(19) United States
(12) Patent Application Publication
(10) Pub. No.: US 2016/0181909 A1
(43) Pub. Date: Jun. 23, 2016

(54) ELECTRIC UNIT FOR A PUMP-STORAGE POWER PLANT

(71) Applicant: ABB Technology AG, Zuerich (CH)

(72) Inventors: Peter Steimer, Ehrendingen (CH); Stefan Linder, Zofingen (CH); Steve Aubert, Wallisellen (CH); Tobias Thurnherr, Baden (CH)

(21) Appl. No.: 15/056,557

(22) Filed: Feb. 29, 2016

Related U.S. Application Data
(63) Continuation of application No. PCT/EP2014/068504, filed on Sep. 1, 2014.

(30) Foreign Application Priority Data
Aug. 30, 2013 (EP) 13182394.0
Sep. 10, 2013 (DE) 102013014830.8

(51) Int. Cl. H02M 1/36; F01D 15/10; H02J 11/00

(52) U.S. Cl. CPC H02M 1/36; H02J 11/00; F01D 15/10

(57) ABSTRACT

The invention relates to a pumped storage power plant, in particular to an electric unit 1 comprising a converter 3, a rotating electric synchronous machine 4 and a charging unit 5, wherein the charging unit 5 has at least one transformer 6 and one switch 7 and can be connected to a supply grid 2, on the one hand, and to the converter 3, on the other. The invention also relates to a method for using the electric unit 1 comprising at least opening a generator switch 15 in order to disconnect the synchronous machine 4 from the converter 3; charging cells of the converter 3 which have capacitors and/or accumulators by closing a switch 7 of the charging unit 5, wherein by closing the switch 7 the converter 3 is connected to the supply grid 2 via the transformer 6 of the charging unit 5; opening the switch 7 of the charging unit 5 after the complete charging of the converter 3; and closing the generator switch 15 in order to connect the synchronous machine 4 to the converter 3 and/or the secondary line 11.

### TECHNICAL BACKGROUND

The invention relates to a pumped storage power plant, in particular an electric unit for same comprising a converter and a rotating electric synchronous machine, wherein the synchronous machine can be connected to the power grid via the converter.

### PRIOR ART

Regenerative energy sources such as, for example, wind energy and solar energy are supplying a continuously increasing proportion of our electricity needs. However, these energy sources have irregular operating times in this context. Therefore, direct and continuous supply of consumers with electricity from these energy sources cannot be ensured. For this purpose, energy stores are used which permit rapid changeovers between an excess of electricity and a deficit of electricity and whose power and direction of energy flow can be changed quickly and continuously.

Different systems are available here as energy stores, said systems being each particularly suitable for specific quantities of energy. For small quantities of energy, up to approximately 100 MWh, flywheel energy stores or battery stores are used. For medium to large quantities of energy of approximately 100 MWh to 1 GWh compressed air stores are particularly suitable. For large quantities of energy, typically above 100 MWh and usually above 1 GWh pumped stores are used.

Pumped stores or pumped storage power plants are of particular interest owing to the large quantity of energy which can be stored. In this context, when there is excess electricity water is pumped from a first storage reservoir, which is natural or created artificially for this purpose, into a second storage reservoir which is at a higher location. The electrical energy is converted into potential energy. In order to recover electricity, water is conducted from the storage reservoir which is at a higher location back into the lower storage reservoir via a turbine.

Modern pumped stores have drives with a variable rotational speed. As a result of decoupling of the rotational speed of the machines from a power grid frequency, pump speeds and turbine speeds can be set in such a way that they are operated near to the optimum efficiency level. In this context, the variation of the rotational speed in the pumping mode permits the power consumption to be adjusted freely. In particular, systems with a variable rotational speed can be quickly connected to the power grid, or synchronized therewith, from the stationary state.

Pumped stores according to the prior art have asynchronous machines with double feeds and power electronic converters, permitting the rotational speed of a pump and of a turbine to be regulated. Therefore, on the one hand a pumping capacity is regulated and, on the other hand, the efficiency level of the installation can be increased when necessary.

In one embodiment for regulating the rotational speed of the pump or of the turbine, a synchronous machine is used whose stator is fed by means of a three-phase current with an adjustable frequency. The conversion of the frequency is brought about here using a combination of a rectifier and a power inverter which are connected to one another via an intermediate voltage circuit or power circuit.

When such a synchronous machine which is fed via a converter is used, a starting torque of the synchronous machine is sufficient to, for example, permit the pump from the stationary state without previous blowing out of a water column from the pump. Furthermore, the stator can be configured to be smaller than, for example, in the case of a double-feed asynchronous machine, since, on the one hand, only effective power flows and, on the other hand, no energy circulates within the synchronous machine. A simplified design of the rotor results in the possibility of operating the synchronous machine at a relatively high rotational speed and in a broad rotational speed range. This is significant, in particular, in the case of pumped storage power plants with a high power and a large drop height of the water which runs down.

A significant disadvantage of the invention according to the prior art is that the converter is subjected to a very high switch-on current when it is connected to the power grid. The very high switch-on current is caused by the charging of capacitors and accumulators of cells of the converter. This high switch-on current signifies a very high loading on the converter and its components, which ultimately brings about a defect or a high level of wear and a reduced service life of the converter. In this context, failure of the converter entails very high maintenance costs and downtimes of the installation. Moreover, possible down times directly affect the costs of the electric unit.

Furthermore, the components of the converter have to be configured in such a way as to be able to withstand the high switch-on current at all, which results in increased investment costs when installing the electric unit.

In view of the above, the present invention is based on the object of making pumped storage power plants more failsafe and more cost-effective.

### DESCRIPTION OF THE INVENTION

This object is achieved by means of an electric unit for a pumped storage power plant according to claim 1 and a method for its application according to claim 8. Further advantageous refinements become apparent from the dependent claims wherein the backreferences of the claims do not exclude any further appropriate claim combinations.

The invention provides here an electric unit for a pump storage power plant, wherein said electric unit can be connected to a power grid for transmitting electrical energy, and to a supply grid. The electric unit comprises here at least one converter or frequency converter and a rotating electric synchronous machine which serves as a motor or a generator depending on the operating mode of the synchronous machine. The synchronous machine can, for example, be mechanically connected to a turbine or water turbine and a pump or water pump or to a reversible pump turbine and is provided underneath a storage reservoir.

Furthermore, the electric unit comprises a charging unit, wherein the charging unit has at least a transformer, a resistor or a specific converter (soft starter) in conjunction with a switch and can be connected to the supply grid, on the one hand, and to the converter, on the other. In this context, the supply grid to which the charging unit is connected can be identical to the power grid to which the converter is connected or can differ therefrom. The charging unit serves here to charge capacitors and accumulators of cells of the converter in order to prevent high switch-on currents when the converter is connected to the power grid and therefore to reduce the loading on the converter and its components, to increase the fail safety of the converter and to lengthen the service life of the converter. The switch-on current during the charging of the cells of the converter is limited by means of the transformer of the charging unit, and the charging takes place slowly compared to a direct connection of the converter. If necessary, an additional power electronic soft starter can be used to limit the switch-on current further. Soft starters can comprise mechanical and electronic components here, wherein, for example, the mechanical component functions similarly to a slip clutch, and the electronic component reduces a current or a voltage.

In one advantageous refinement, the charging unit can have a transformer in order to make available an alternating voltage at the converter side.

In one advantageous refinement, the converter can have a frequency converter and grid-side switching elements and machine-side switching elements. The frequency converter comprises at least two electrically connectable elements, wherein, depending on the operation of the machine, one element can be respectively used as a rectifier and one element as a power inverter. A machine-side element is an inverter unit INU and a grid-side element is an active rectifier unit ARU. Furthermore, the converter can have circuit breakers for connecting the potential of the converter at grid-side and machine-side outputs of the elements.

In a further advantageous refinement, the machine and the charging unit can be connected directly or immediately to a block transformer via a secondary line, also referred to as a bypass, wherein the block transformer can be connected to the power grid via a power switch, and the secondary line has a circuit breaker or power switch.

In one advantageous refinement of the invention, a circuit breaker or a generator switch is provided between the charging unit and the machine.

In one advantageous embodiment of the invention, the machine can be connected to the supply grid via an exciter unit, wherein the exciter unit has a rectifier and a transformer. In a particularly advantageous refinement, the charging unit and the exciter unit are embodied as one integrated unit.

In a further advantageous embodiment there is provision that the converter is embodied as a modular multilevel converter. Furthermore, a black start assembly for supplying energy from the supply grid can be connected thereto. Therefore, even if the supply grid fails, the electric unit can be powered up in order to connect the synchronous machine to the power grid.

The invention also relates to a system of a pumped storage power plant, characterized in that the system has an electric unit as described above and a turbine and/or pump and/or a pump turbine coupled to the synchronous machine.

The invention also relates to a method for using an electric unit for a pumped storage power plant comprising a rotating electric synchronous machine and a converter, wherein the machine can be connected via the converter and a block transformer to a power grid for transmitting electrical energy, and to a supply grid, and wherein the block transformer can be disconnected from the power grid by means of a circuit breaker or power switch, and a generator switch is provided between the charging unit and the machine. The method comprises here opening the power switch in order to disconnect the block transformer from the power grid; opening the generator switch in order to disconnect the machine from the converter; charging cells of the converter which have capacitors and/or accumulators by closing a switch of the charging unit, wherein by closing the switch the converter is connected to the supply grid via a transformer of the charging unit; and closing the generator switch in order to connect the machine to the converter and/or the secondary line. After the complete charging of the converter, the switch of the charging unit can be opened.

In one advantageous embodiment, the method comprises in this context the fact that the charging of the cells of the converter has a first charging period, wherein switching elements of the converter are switched in such a way that machine-side cells of the converter are charged completely or at least almost completely up to approximately 90 to 95% and grid-side cells of the converter are charged partially, for example up to 45 to 50%.

In a further advantageous embodiment, the method comprises the fact that the charging of the cells of the converter has a second charging period, wherein switching elements of the converter are switched in such a way that the grid-side cells of the converter are charged completely.

In a particularly advantageous embodiment, the method optionally comprises the fact that after the charging of the cells of the converter the method also comprises magnetizing the block transformer by correspondingly controlling the switching elements of the converter; and closing the power switch in order to connect the block transformer to the power grid. In this context, in a further embodiment there can be provision that the power switch of the secondary line is closed in order to magnetize the block transformer. After the complete magnetization of the block transformer, the switch of the charging unit can be opened.

According to the invention, the loading on the converter and its components is reduced, the fail safety of the converter is increased and the service life of the converter is lengthened. By disconnecting the charging process of the cells of the converter from the connection of the converter via the block transformer to the power grid and by limiting the switch-on current via the charging unit, the fail safety of the electric unit is therefore also increased.

### BRIEF DESCRIPTION OF THE DRAWINGS

Further features, details and advantages of the invention emerge from the wording of the claims and from the description of exemplary embodiments with reference to the figure.

The invention will be explained in further details on the basis of the following text with reference to preferred exemplary embodiments on the basis of the figure.

FIG. 1 shows a schematic illustration of an electric unit having a converter, an electric synchronous machine and a charging unit,

FIG. 2 shows a schematic illustration of the electric unit from FIG. 1 with an additional assembly, and

FIG. 3 shows a schematic illustration of a system of a pumped storage power plant.

The reference symbols and their meaning are combined in the list of reference symbols. In general, the same reference symbols denote the same parts.

### DETAILED DESCRIPTION OF EXEMPLARY EMBODIMENTS

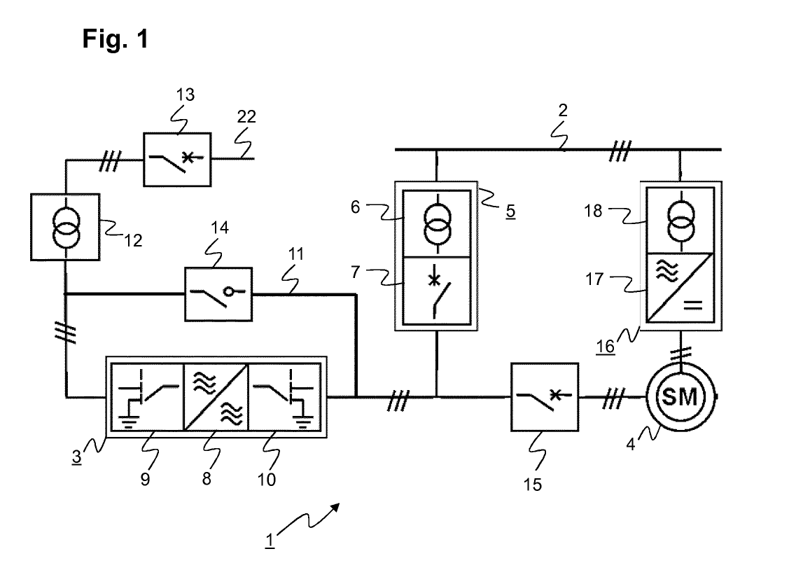

FIG. 1 shows a schematic illustration of an electric unit 1 connected to a power grid 22 for transmitting electrical energy, and to a supply grid 22. The power grid 22 is typically coupled to the supply grid 2 via a transformer and power switch, not shown in the figures. In principle, the power grid 22 could also be identical to the supply grid 2.

The electric unit 1 comprises here a converter 3 and a rotating electric synchronous machine 4, referred to below as machine 4. The machine 4 can be accommodated here, for example, in a cavern for reasons of local conditions or for protection.

Furthermore, the electric unit 1 has a charging unit 5, wherein the charging unit 5 can be connected to the supply grid 2, on the one hand, and to the converter 3, on the other.

The charging unit 5 can have at least one transformer 6 and one switch 7. In addition, the charging unit 5 makes available an alternating voltage on the converter 3 side.

The charging unit 5 in this context is used to charge capacitors and accumulators of cells of the converter 3 in order to prevent high switch-on current when the converter 3 is connected to the power grid 22 and therefore to reduce the loading on the converter 3 and its components. In this context, the switch-on current during the charging of the cells of the converter 3 is limited by means of the transformer 6 of the charging unit 5, and the charging takes place slowly compared to a direct connection of the converter 3 to the power grid 2.

The converter 3 has a frequency converter 8 and grid-side switching elements 9 and machine-side switching elements 10. The switching elements 9, 10 or else a first and second circuit breaker can be provided upstream of the grid-side rectifier or power inverter of the converter 3, also referred to as active rectifier unit, and the machine-side rectifier or power inverter of the converter 3, also referred to as inverter unit, in order to connect the potential of the converter 3, for example to perform maintenance on the converter. Frequency conversion is produced here by means of a combination of a rectifier and a power inverter which are connected to one another via a concentrated or distributed intermediate voltage circuit or intermediate power circuit. The intermediate circuit in this context also has units for storing energy in, for example, capacitors in the case of an intermediate voltage circuit and inductors in the case of an intermediate power circuit.

In order to bypass the converter 3, for example to perform maintenance on the converter 3, the electric unit has a secondary line 11 or a bypass, wherein the latter also has a circuit breaker or a power switch 14.

In the illustrated embodiment, in order to regulate the rotational speed of a pump or turbine which is coupled to the synchronous machine 4, the machine 4 is fed by means of a three-phase current with an adjustable frequency. The machine 4 is for this purpose connected to the supply grid 2 via an exciter unit 16 comprising a rectifier 17 and a transformer 18.

Furthermore, in the case of the grid operation of the machine 4 during operation via the secondary line 11, the grid-side part of the converter 3 can regulate an effective power, wherein the machine-side part of the converter is switched off or also used when the secondary line 11 is closed. In this context, it can be advantageous to provide its impedances between the power switch 14 and the converter 3. The converter 3 can therefore additionally make available 100% reactive power. In order to support the grid in the case of faults, up to 140% apparent power is therefore available even without regulation of the reactive power by means of the excitement of the machine 4. By including the additional regulation of the reactive power by the machine 4, significantly more reactive power is available depending on the operating state of the machine 4. In particular, as a result of this arrangement reactive power is available even when the machine is not operating. This permits reactive power to be made available with significantly lower losses. Furthermore, the converter 3 can be operated in a phase shifter mode even when the machine is stationary.

The machine 4 and the charging unit 5 are connected to the block transformer 12 directly or immediately via the secondary line 11, wherein the block transformer 12 is connected to the power grid 22 via a power switch 13. In the illustrated embodiment, the charging unit 5 and the exciter unit 16 are embodied separately from one another, in this context there is also a possibility of providing the latter in an integrated unit.

Furthermore, the operation of the machine 4 with a freely selectable rotational speed has considerable advantages, in particular it is possible to use established, reliable and low-maintenance generator technology. Furthermore, there is the possibility of operating a pump and a turbine independently of one another in their optimum rotational speed range. By using the synchronous machine 4, in particular high rotational speeds can also be implemented, for example for large gradients. Furthermore, the operationally accessible rotational speed range extends continuously from zero to the maximum rotational speed and is limited only by the operational limits of the pump and of the turbine. The pump and the turbine can in principle be combined in one unit, for example a pump turbine. In particular, there is the possibility of retrofitting of relatively old installations to a variable frequency operation, without replacing the existing generator. A further advantage is a very quick grid coupling and the possibility of generating positive and negative reactive power in the frequency converter 8, and the generator can therefore be operated exclusively with effective power, as a result of which the generator has a relatively compact design. Furthermore, by using the frequency converter 8 it is possible to switch over quickly, for example from the pump operation to the turbine operation.

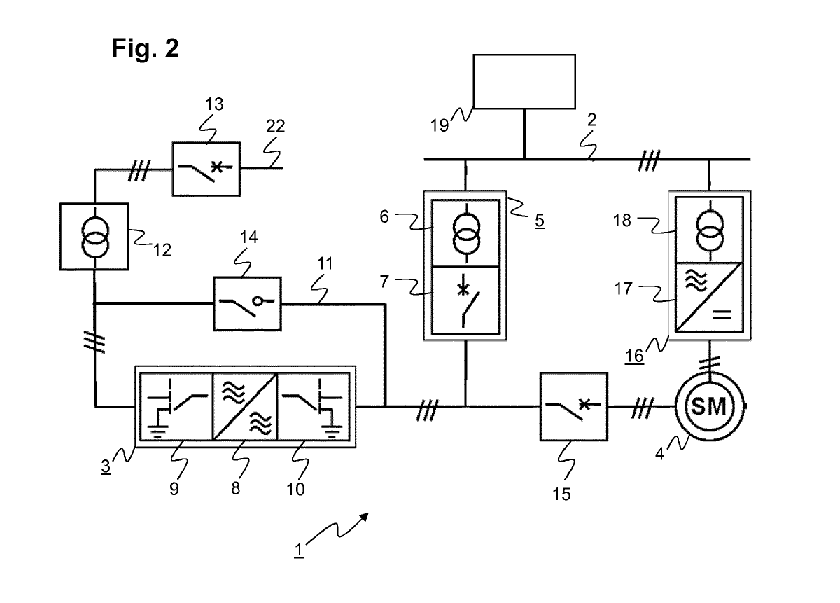

FIG. 2 shows a schematic illustration of the electric unit 1 from FIG. 1 with an additional assembly which can be embodied as a black starter assembly 19, or also as an emergency power assembly. The black starter assembly 19 can comprise here, for example, a diesel engine or a gas turbine and a generator and supplies the supply grid 2 with energy to operate the electric unit 1 of the pumped storage power plant. The black starter assembly 19 permits the pumped storage power plant to power up independently of the supply grid 2 in the switched-off state and to connect to the power grid 22. This is significant, in particular in the case of a power failure over a large area, in order to activate the power grid 22 again.

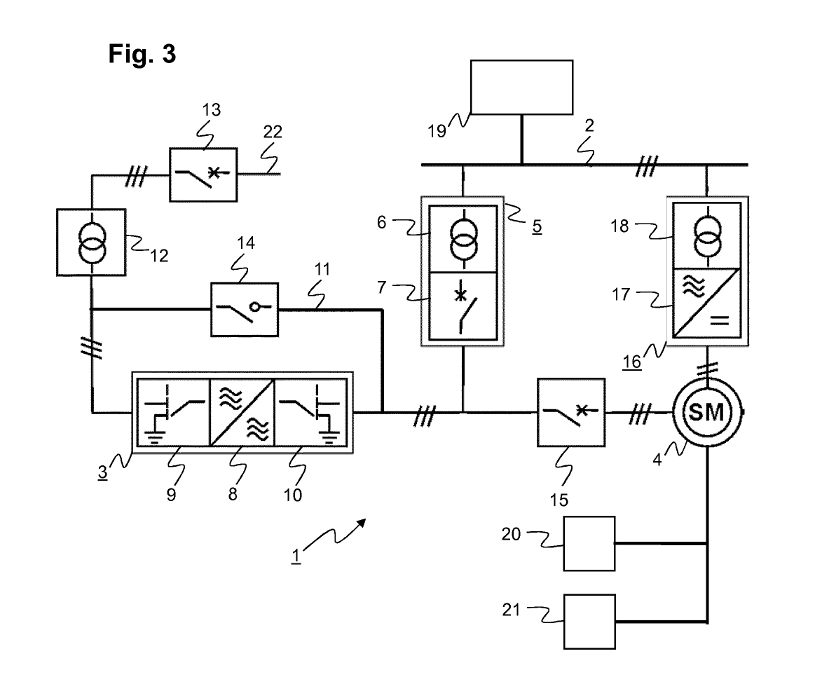

FIG. 3 shows a schematic illustration of a system of a pumped storage power plant according to FIG. 1 and FIG. 2, wherein the machine 4 is connected to a turbine 20 and to a pump 21. The pump 20 and the turbine 21 can be provided separately as illustrated here or can be embodied as a pump turbine. The pumped storage power plant can therefore use excessive electricity to pump water, by means of the pump 21, from a first storage reservoir (not shown) which is natural or created artificially for this purpose, into a second storage reservoir at a higher location (not shown). The electrical energy is converted here into potential energy. In order to recover electricity, water is conducted back from the storage reservoir at a higher location to the lower storage reservoir via the turbine 20, and energy is fed into the power grid 22 via the electric unit 1.

In the text which follows, an exemplary embodiment for using the electric unit 1 is described, the exemplary embodiment and the features thereof are not to be considered restrictive here.

In a method for using the electric unit 1 for a pumped storage power plant, the charging unit 5 is used, on the one hand, to charge slowly cells of the converter 3 which have capacitors and/or accumulators, before the direct connection of the converter 3 to the power grid 22, at least compared to the direct connection of the converter 3 to the power grid 22, and, on the other hand, to charge or to magnetize the block transformer 12 slowly, at least compared to the direct connection of the block transformer to the power grid 22.

In the case of pumped storage power plants, the machine 4 is used as a motor or generator depending on an excess or deficiency of energy in the power grid 22. In this context, the electric unit is frequently disconnected from the power grid 22, for example in order to switch over the operating mode as a motor or generator. In this context, the cells of the converter 3 and the block transformer 12 frequently have to be recharged or re-magnetized. The electric unit which is described in accordance with this invention is used to carry out this process in a non-damaging fashion for the components of the converter 3 and of the block transformer 12.

An exemplary embodiment of the method for using the electric unit 1 comprises here firstly opening the power switch 13 to disconnect the block transformer 12 from the power grid 22 insofar as said block transformer 12 is not already disconnected from the power grid 22. This is normally the case if the cells of the converter 3 or block transformer 12 have to be charged or magnetized.

In a further step, the generator switch 15 is opened in order to disconnect the machine 4 from the converter 3 and the charging unit 5. This prevents the machine 4 from adversely affecting the charging process or from drawing power from the charging unit 5 itself.

In a subsequent step, the cells of the converter 3 which have capacitors and/or accumulators are charged, wherein the switch 7 of the charging unit 5 is closed, and the converter 3 is therefore connected to the supply grid 2 via the transformer 6 of the charging unit 5. In this context, the switch-on current during the charging of the cells of the converter 3 is limited by means of the transformer 6 of the charging unit 5, and the charging takes place slowly compared to a direct connection of the converter 3.

The charging of the cells of the converter 3 can take place in multiple steps here. One embodiment of the method comprises in this context the fact that the charging of the cells of the converter 3 has a first charging period, wherein switching elements 9, 10 of the converter 3 are switched in such a way that machine-side cells of the converter 3 are charged completely or almost completely and grid-side cells of the converter 3 are charged only partially. In the first charging period, the switch-on current is therefore limited by virtue of the fact that only some of the cells are charged.

A further embodiment of the method comprises in this context the fact that the charging of the cells of the converter 3 has a second charging period, wherein switching elements 9, 10 of the converter 3 are switched in such a way that the grid-side cells of the converter 3 are charged completely. This can take place, for example, by means of an equalizing current within the converter 3, wherein the power of machine-side cells of the converter 3 is transmitted to the grid-side cells of the converter 3. Under some circumstances, renewed charging of the machine-side cells of the converter 3 is necessary in the second charging period.

In a further step of the method, the block transformer 12 can be magnetized by correspondingly controlling the switching elements 9, 10 of the converter 3, wherein the power switch 13 of the secondary line 11 is closed in order to magnetize the block transformer 12. In this context, an equalizing current keeps the cells of the converter 3 equalized. After the conclusion of the entire magnetization of the block transformer 12, the switch 7 of the charging unit is opened again.

In order to activate the electric unit 1 for the pumped storage power plant, the power switch 13 is closed in order to connect the block transformer 12 to the power grid 22. The generator switch 15 is subsequently closed in order to connect the machine 4 to the power grid 22 via the converter 3 and/or the secondary line 11.

### LIST OF REFERENCE NUMBERS

1 Electric unit
2 Power grid
3 Converter
4 Machine
5 Charging unit
6 Transformer
7 Switch
8 Frequency converter
9 Switching element
10 Switching elements
11 Secondary line
12 Block transformer
13 Power switch
14 Power switch
15 Generator switch
16 Exciter unit
17 Rectifier
18 Transformer
19 Black starter assembly
20 Turbine
21 Pump
22 Power grid

1-16. (canceled)

17. An electric unit for a pumped storage power plant, which electric unit can be connected to at least one power grid for transmitting electrical energy, comprising:
at least one converter,
a rotating electric synchronous machine, and a generator switch, the synchronous machine can be connected to the power grid via the converter), and has an excitation means,
by means of which exciter unit the synchronous machine can be connected to a supply grid, wherein
the electric unit has a charging unit for charging capacitors and accumulators of cells of the converter, wherein
the charging unit has at least one switch, the charging unit can be connected to the supply grid, on the one hand, and to the converter, on the other, and wherein the generator switch is arranged between the charging unit and the synchronous machine.

18. The electric unit as claimed in claim 17, wherein the charging unit has a transformer in order to make available an alternating voltage on the converter side.

19. The electric unit as claimed in claim 17, wherein the converter has a frequency converter and grid-side switching elements and machine-side switching elements.

20. The electric unit as claimed in claim 18, wherein the converter has a frequency converter and grid-side switching elements and machine-side switching elements.

21. The electric unit as claimed in claim 17, wherein the synchronous machine and the charging unit can be connected directly to a block transformer via a secondary line, wherein the block transformer can be connected to the power grid via a power switch, and the secondary line has a power switch.

22. The electric unit as claimed in claim 18, wherein the synchronous machine and the charging unit can be connected directly to a block transformer via a secondary line, wherein the block transformer can be connected to the power grid via a power switch, and the secondary line has a power switch.

23. The electric unit as claimed in claim 19, wherein the synchronous machine and the charging unit can be connected directly to a block transformer via a secondary line, wherein the block transformer can be connected to the power grid via a power switch, and the secondary line has a power switch.

24. The electric unit as claimed in claim 21, wherein the exciter unit has a rectifier and a transformer.

25. The electric unit as claimed in claim 17, wherein the charging unit and the exciter unit are embodied as one integrated unit.

26. The electric unit as claimed in claim 18, wherein the charging unit and the exciter unit are embodied as one integrated unit.

27. The electric unit as claimed in claim 17, wherein the converter is embodied as a modular multilevel converter.

28. The electric unit as claimed in claim 18, wherein the converter is embodied as a modular multilevel converter.

29. The electric unit as claimed in claim 17, which further includes a black start assembly for supplying energy from the supply grid is connected thereto.

30. The electric unit as claimed in claim 18, which further includes a black start assembly for supplying energy from the supply grid is connected thereto.

31. A system of a pumped storage power plant, comprising:
at least one converter,
a rotating electric synchronous machine, and a generator switch, the synchronous machine can be connected to a power grid via the converter, and has an excitation means,
by means of which exciter unit the synchronous machine can be connected to a supply grid, wherein
the electric unit has a charging unit for charging capacitors and accumulators of cells of the converter, wherein the charging unit has at least one switch, the charging unit can be connected to the supply grid, on the one hand, and to the converter, on the other, and wherein the generator switch is arranged between the charging unit and the synchronous machine, and
at least one of a turbine and/or pump and/or pump turbine is coupled to the synchronous machine.

32. A method for charging an electric unit for a pumped storage power plant comprising a converter, a rotating electric synchronous machine and a charging unit, wherein the synchronous machine can be connected via the converter and a block transformer to a power grid for transmitting electrical energy, and to a supply grid, wherein the block transformer can be disconnected from the power grid by a power switch, and a generator switch is provided between the charging unit and the synchronous machine, the method comprising:
opening the generator switch in order to disconnect the synchronous machine from the converter;
charging cells of the converter which have capacitors and/or accumulators by closing a switch of the charging unit, wherein by closing the switch the converter is connected to the supply grid via a transformer of the charging unit; and
closing the generator switch in order to connect the synchronous machine to the converter and/or the secondary line.

33. The method of claim 32, wherein the charging of the cells of the converter has a first charging period, wherein switching elements of the converter are switched in such a way that machine-side cells of the converter are charged completely and grid-side cells of the converter are charged partially.

34. The method of claim 32, wherein the charging of the cells of the converter has a second charging period, wherein switching elements of the converter are switched in such a way that the grid-side cells of the converter are charged completely.

35. The method of claim 32, wherein after the charging of the cells of the converter the method also comprises
magnetizing the block transformer by correspondingly controlling the switching elements of the converter; and
closing the power switch in order to connect the block transformer to the power grid.

36. The method of claim 32, wherein the power switch of the secondary line is closed in order to magnetize the block transformer.
